(19) United States
(12) Patent Application Publication
(10) Pub. No.: US 2026/0327725 A1
(43) Pub. Date: Oct. 22, 2026

(54) IMPROVED METAL PRODUCTION

(71) Applicant: The University of Birmingham, Edgbaston, Birmingham (GB)

(72) Inventors: Yulong DING, Edgbaston, Birmingham (GB); Harreit KILDAHL, Edgbaston, Birmingham (GB)

(21) Appl. No.: 19/112,288

(22) PCT Filed: Sep. 20, 2023
(86) PCT No.: PCT/GB2023/052427

§ 371 Date: Mar. 17, 2025

(30) Foreign Application Priority Data
Sep. 20, 2022 (GB) 2213759.0

(51) Int. Cl. C21B 7/00; C21B 13/00; C21B 13/02

(52) U.S. Cl. CPC C21B 7/002; C21B 13/0073; C21B 13/026; C21B 2100/22; C21B 2100/80

(57) ABSTRACT

A system (100) for metal production, the system comprising: a reducing furnace (110) configured to receive metal ore (101) and process gas (102) and to output hot metal (115) and reducing furnace top gas (111); and a first thermochemical reactor (130) configured to, in a first mode, receive at least a portion (163) of the reducing furnace top gas (111), and to produce carbon monoxide from carbon dioxide in the portion (163) of the blast reducing furnace top gas (111) by oxidation of a thermochemical compound and to return at least a portion of the produced carbon monoxide (151) to the reducing furnace (110).

### TECHNICAL FIELD

The present invention relates to a system and method for production of liquid metal. In particular the invention relates to a system and method for metal production with reduced carbon footprint.

### BACKGROUND

The iron and steel sector is a major greenhouse gas emitter, releasing up to 9% of global CO₂ emissions. Steel is firmly in the category of hard-to-decarbonise sectors due to the inherent energy and carbon intensive nature of its production which involves very high temperature processes. Indeed, more carbon dioxide is released on a weight basis than steel produced, with 1.89 tonnes of CO₂ released for every tonne of steel produced using today's technology. The main reason for this is the use of coking coal as an energy source and structural support, making up a 74% share of the total energy feedstock and accounting for 15% of total global coal consumption.

There are currently two main methods of steel production, the blast furnace-basic oxygen furnace (BF-BOF) route accounting for 71% of production, and natural gas based direct reduction of iron followed by an electric arc furnace (DRI-EAF) making up the other 29%. The BF-BOF route will be discussed in detail below but generally both methods consist of two parts. Firstly, iron ore is reduced to metallic iron in the BF or DRI before being converted to steel by reducing the carbon content in the metal in the BOF or EAF.

There are a few technologies that are being researched to decarbonise the steel industry. The first option is to close down the old BF-BOFs and replace them with DRI-EAFs. If the EAF is powered by renewable electricity, it has the potential to save 1.5Gt of CO₂ emissions annually. However, a typical large scale DRI-EAF plant costs between $1.1 and $1.7 billion to build. Combined with the stranded assets of the old BF-BOF plant, the cost makes this switch economically unfeasible in the short time periods needed to meet the Paris Climate Agreement. A second option is to increase scrap recycling. Steel is already one of the most recycled materials, with an 84% recycling rate in 2017. In 2019, 32% of all inputs were scrap. Scrap recycling results in a 90% reduction of CO₂ emissions and 70% energy savings compared with virgin iron ore in a BF-BOF. Additionally, each tonne of scrap steel reused displaces 1400 kg of iron ore, 740 kg of coal and 120 kg of limestone. The proportion of scrap steel in the input can be up to 100% in an EAF while 20-25% is currently the maximum input for a BF-BOF. It is expected that the share of scrap in inputs could increase to 46% by 2050 and although this is not sufficient to decarbonise the sector alone, it could result in significant CO₂ emission reductions.

Another decarbonisation option is to use hydrogen for the direct reduction of iron (HDRI), followed by EAF. If renewable electricity is used to power an electrolyser to make green hydrogen, this could dramatically reduce emissions. However, this requires new DRI plants to be built to replace BF-BOFs and has a Technological Readiness Level (TRL) of 5-7, meaning the technology has been demonstrated but is not industrially operational. It has been estimated that a carbon price of $67/tCO₂ eq would be needed to enable HDRI to produce steel at the same price as a traditional blast furnace, provided there is sufficient low-cost renewable electricity. Additionally, reducing iron with hydrogen is less efficient at lower temperatures than carbon monoxide, with the reduction from Fe₂O₃ to Fe₃O₄ occurring more readily under CO. Conversely, the reduction of Fe₃O₄ to Fe at higher temperatures occurs more readily under hydrogen. Modelling suggests that hydrogen based DRI could reduce emissions in the EU steel industry by 35% at current grid emission levels while requiring 3.72 MWh per tonne of liquid steel produced. For reference, a BF-BOF uses 3.48 MWh/t. The cost of hydrogen production remains prohibitive.

A related technology is natural gas DRI with carbon capture, use and storage (CCUS), which also has a TRL of 5-7. Although several methods of CCUS have been demonstrated and a few industrial CCUS facilities are operational, the cost is expected to be $100 per tonne of CO₂ for capture and $160 per tonne for transport and storage by 2030, with costs falling moderately by 2050. Given the extremely high emissions from iron and steel facilities, large CCUS plants would be required but emissions reductions are estimated to be between 20-80%. Finally, another proposed solution is iron ore electrolysis, which has a TRL of 6. This technique is already used on a large scale for the manufacture of aluminium, so the technology has been proven on an industrial scale, though at a much lower temperature than ironmaking and steelmaking processes. High temperatures and optimisation of the electrodes and electrolyte are needed for the efficient reduction of iron ores.

In summary, steel production accounts for 9% of global CO₂ emissions and must be rapidly decarbonised to limit warming to 1.5° C. Seventy percent of existing iron and steel facilities rely on the extremely energy intensive and emission heavy high temperature BF-BOF route. Most of the current methods of decarbonising this sector rely on the phase out of these BF-BOF plants and the implementation of lower carbon methods such as EAF and DRI plants. This will be extremely costly.

Technologies that are applicable to the production of iron and steel are also potentially applicable in other production processes that use carbon monoxide as a reducing agent in a reducing furnace.

Accordingly, there exists a need for a way to decarbonise metal production that at least ameliorates the above identified problems.

### SUMMARY

According to a first aspect of the present invention there is provided a system for metal production, the system comprising:
a reducing furnace configured to receive metal ore and process gas and to output hot metal and reducing furnace top gas;
a first thermochemical reactor configured to, in a first mode, receive at least a portion of the reducing furnace top gas, and to produce carbon monoxide from carbon dioxide in the portion of the reducing furnace top gas by oxidation of a thermochemical compound and to return at least a portion of the produced carbon monoxide to the reducing furnace.

The reducing furnace may comprise a blast furnace or a DRI furnace.

The metal may be iron. The system may be for iron and/or steel production.

The first thermochemical reactor may comprise a series of sub-reactors. The sub-reactors may be operated in series, so that CO₂ from the first sub-reactor can be further reduced in a subsequent sub-reactor (and so on).

The system may further comprise a gas separator configured to: receive the reducing furnace top gas, separate carbon dioxide from the other constituents of the reducing furnace top gas, and provide the carbon dioxide portion of the reducing furnace top gas to the first thermochemical reactor.

The gas separator may be further configured to separate carbon monoxide from the other constituents of the reducing furnace top gas for returning to the reducing furnace.

The thermochemical compound may comprise (or consist essentially of) a metal oxide, a perovskite material or a double perovskite material. The thermochemical compound may comprise a double perovskite barium calcium iron niobate or a perovskite barium magnesium iron niobate. The thermochemical compound may comprise Ba₂Ca_{0.66}Nb_{0.34}FeO₆ or BaMg_{0.33}Nb_{0.34}Fe_{0.33}O₃.

The first thermochemical reactor may be configured to, in a second mode, produce oxygen by reduction of the thermochemical compound. Reducing the thermomechanical compound may comprise using green hydrogen from renewable sources.

The system may further comprise a controller configured to switch or cycle between the first mode, in which the first thermochemical reactor receives carbon dioxide from the reducing furnace top gas and produces carbon monoxide by oxidation of the thermochemical compound, and a second mode in which the first thermochemical reactor produces oxygen by reduction of the thermochemical compound.

The system may further comprise a second thermochemical reactor, wherein in the first mode, the second thermochemical reactor produces oxygen by reduction of the thermochemical compound, and in the second mode, the second thermochemical reactor receives carbon dioxide from the reducing furnace top gas and produces carbon monoxide by oxidation of the thermochemical compound. The system may be configured to operate the first and second thermochemical reactors in a cycle (cycling between the first and second modes) for continuous supply of carbon monoxide and oxygen.

The system may further comprise a steel furnace (which may comprise a basic oxygen furnace or an electric arc furnace), the steel furnace configured to receive the hot metal from the reducing furnace and the oxygen from the first thermochemical and/or the second thermochemical reactor, and to output molten steel and steel furnace gas.

The gas separator may be configured to separate nitrogen from the reducing furnace top gas and to provide the nitrogen to the first thermochemical reactor and/or the second thermochemical reactor for reduction of the thermochemical compound.

The gas separator may be configured to separate carbon monoxide from the basic oxygen furnace gas for returning to the reducing furnace.

The system may comprise a first thermochemical reactor gas separator, configured to receive an output gas from the first thermochemical reactor in the first mode, and to separate carbon monoxide from the output gas. The system may comprise a second thermochemical reactor gas separator, configured to separate oxygen from the output gas from the first thermochemical reactor in the second mode. The first thermochemical reactor gas separator may be configured to receive an output gas from the second thermochemical reactor in the second mode and to separate carbon monoxide from the output gas. The second thermochemical reactor gas separator may be configured to receive an output gas from the second thermochemical reactor in the first mode.

The system may comprise a regenerative heat exchanger, configured to extract heat from the reducing furnace top gas, and/or from the steel furnace gas. The regenerative heat exchanger may be configured to provide the heat to the process gas and/or the first thermochemical reactor and/or the second thermochemical reactor.

The system may comprise a heater (e.g. powered by renewables or other zero-carbon, low carbon sources) configured to provide heat to the first thermochemical reactor and/or the second thermochemical reactor.

The system may comprise a heat exchanger for removing heat from a reduction process gas, or from oxygen produced from a reduction process gas, and providing the heat to at least one of: the first and second thermochemical reactors, the CO storage tank or the process gas.

The first thermochemical reactor and second thermochemical reactor may together be configured to provide at least 50% of carbon monoxide used in the reducing furnace for reducing the metal ore to hot metal (or at least 30%, or at least 70%, or at least 80%).

The system may comprise a reducing furnace electrical heater configured to use electrical power to heat the process gas and/or the metal ore introduced to the reducing furnace. The electrical power may be sourced from a carbon neutral source.

According to a second aspect, there is provided a method of producing metal, comprising:
reducing metal ore in a reducing furnace to produce hot metal by reacting carbon monoxide with metal oxide, thereby producing carbon dioxide;
providing at least some of the carbon dioxide produced from the reducing furnace to a first thermochemical reactor and producing carbon monoxide from the carbon monoxide by oxidation of a thermochemical compound;
returning at least a portion of the produced carbon monoxide to the reducing furnace.

The reducing furnace may be a blast furnace or a DRI furnace.

The metal ore may comprise or consist essentially of iron ore. The metal oxide may comprise or consist essentially of iron oxide. The hot metal may be iron.

The carbon dioxide from the reducing furnace provided to the first thermochemical reactor may be obtained by separating carbon dioxide from reducing furnace top gas produced by the reducing furnace.

The method may further comprise separating carbon monoxide from the reducing furnace top gas and returning the carbon monoxide to the reducing furnace.

The thermochemical compound may comprise or consist essential of a perovskite or a double perovskite. The thermochemical compound may comprise or consist essentially of a double perovskite barium niobium ferrite. The thermochemical compound may comprise Ba₂Ca_{0.66}Nb_{0.34}FeO₆.

The method may comprise producing oxygen by reduction of the thermochemical compound in the first thermochemical reactor.

The method may further comprise switching or cycling between a first mode in which the first thermochemical reactor receives carbon dioxide from the reducing furnace top gas and produces carbon monoxide by oxidation of the thermochemical compound, and a second mode in which the first thermochemical reactor produces oxygen by reduction of the thermochemical compound.

In the first mode, a second thermochemical reactor may produce oxygen by reduction of the thermochemical compound, and in the second mode, the second thermochemical reactor may receive carbon dioxide from the reducing furnace top gas and produce carbon monoxide by oxidation of the thermochemical compound.

The method may comprise receiving the hot metal and the oxygen from the thermochemical reactor at a steel furnace (e.g. a basic oxygen furnace or an electric arc furnace), and outputting molten steel and steel furnace gas from the steel furnace.

The method may comprise separating nitrogen from the reducing furnace top gas and providing the nitrogen to the thermochemical reactor for reduction of the thermochemical compound.

The method may comprise separating carbon monoxide from an output gas from the first thermochemical reactor in the first mode, and separating oxygen from the output gas in the second mode.

The method may comprise comprising using the first thermochemical reactor and second thermochemical reactor to provide at least 50% of carbon monoxide used in the reducing furnace for reducing the metal ore to hot metal (or at least 30%, or at least 70%, or at least 80%).

The method may further comprise using electrical power to heat the process gas and/or the metal ore introduced to the reducing furnace.

The method may comprise reducing CO₂ emissions associated with the reducing furnace by at least 50% by replacing coke used as an input to the reducing furnace with gas phase carbon monoxide obtained from output gases (the output gases may include the carbon dioxide produced by the reducing furnace, and flue gases from a steel furnace, such as a BOF or EAF). In some embodiments, CO₂ emissions may be reduced by at least 20%, or at least 75%.

According to a third aspect, there is provided a method of decarbonising a system for producing metal, comprising adding, to a system comprising a reducing furnace, a thermochemical reactor configured to: produce carbon monoxide by reacting a thermochemical compound with carbon dioxide obtained from reducing furnace top gas and providing at least a portion of the produced carbon monoxide to the reducing furnace for reduction of iron oxide.

The reducing furnace may be a blast furnace or a DRI furnace.

The method may comprise adding a gas separator. The method may comprise adding any of the elements referred to with reference to the first aspect, including optional features thereof.

The features of each aspect may be combined with those of any other aspect. Optional features of any aspect may be combined with those of any other aspect. Actions that the system is configured to perform may comprise steps in a method according to an embodiment.

### DETAILED DESCRIPTION

The invention will be described, purely by way of example, with reference to the accompanying drawings, in which:

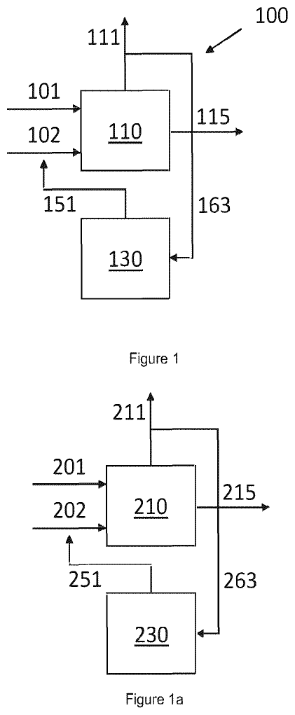

FIG. 1 is a schematic of a TC-BF system comprising a blast furnace and a thermochemical reactor for producing carbon monoxide from carbon dioxide produced by the blast furnace, according to an embodiment;

FIG. 1a is a schematic of a DRI system comprising a DRI furnace and a thermochemical reactor for producing carbon monoxide from carbon dioxide produced by the DRI furnace, according to an embodiment;

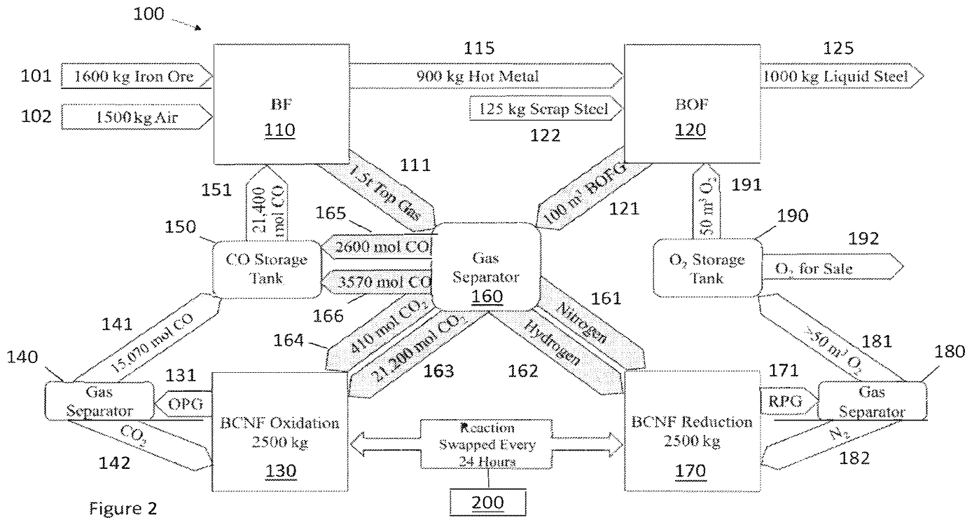

FIG. 2 is a schematic of a TC-BF-BOF system comprising a blast furnace, a basic oxygen furnace and a first and second thermochemical reactor according to an embodiment, in which mass flows are shown;

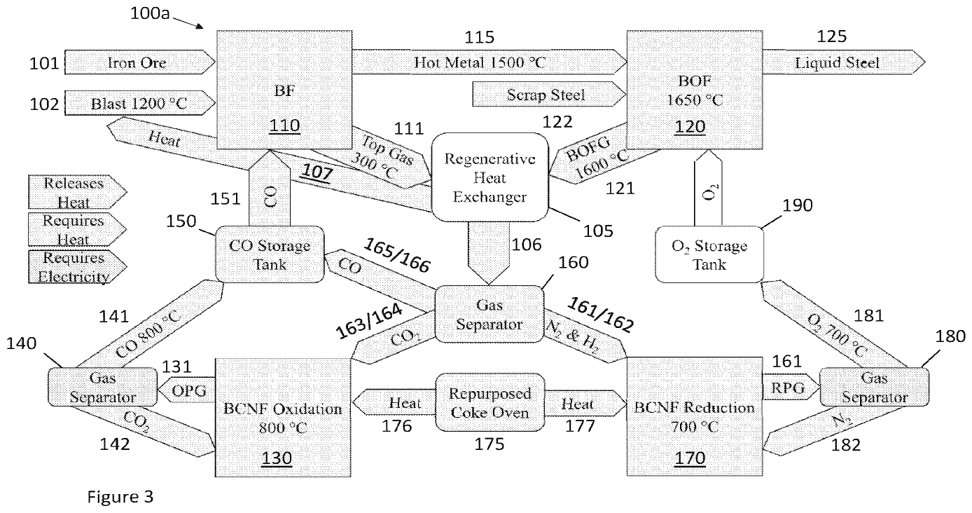

FIG. 3 is a schematic of a TC-BF-BOF system similar to that of FIG. 2, in which heat flows are illustrated;

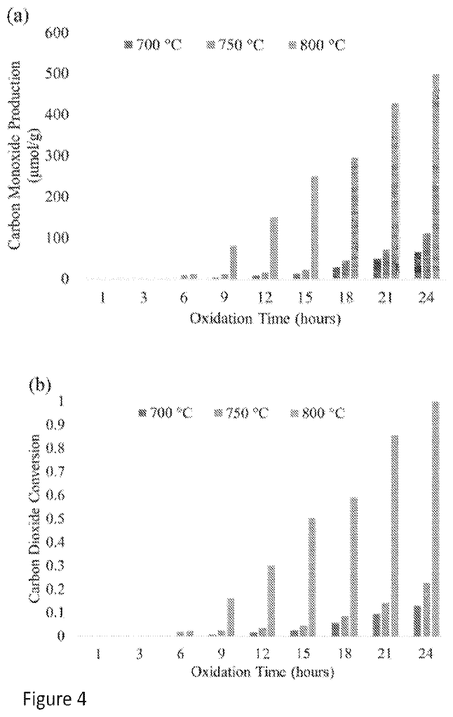

FIG. 4 shows graph of carbon dioxide conversion with respect to oxidation time at a range of different temperatures for an example thermochemical compound

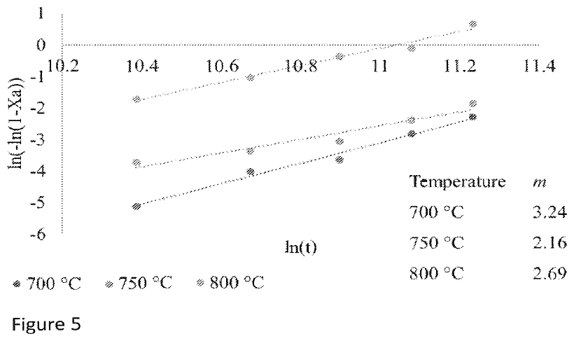

FIG. 5 shows a Hancock and Sharpe plot for the example thermochemical compound; and

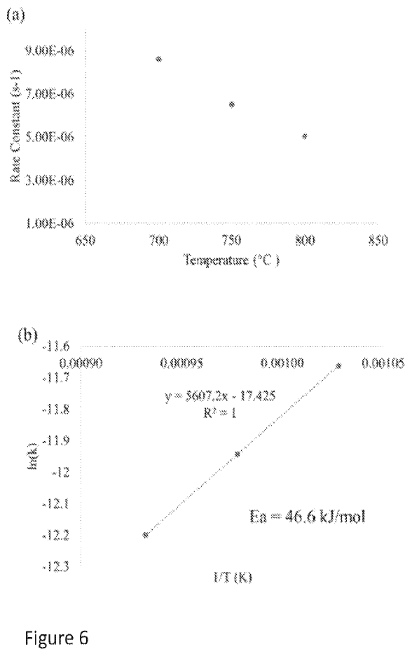

FIG. 6 a) plots a rate constant at each temperature, and b) is an Arrhenius plot for the oxidation of the example thermochemical compound.

Modern blast furnaces can produce over 10,000 tonnes of hot metal a day with the largest furnace as large as 6000 m³. The top of a typical blast furnace is around 200° C. while the bottom can reach temperatures in excess of 1600° C. In existing blast furnaces used for production of iron, iron ore and coke are added to the furnace in layers. Air or oxygen enriched air, also called the blast, is injected at the bottom of the furnace, having been preheated to 1100-1350° C. by regenerative heat exchangers known as hot stoves. This hot blast provides most of the heat needed in the furnace. The hot blast reacts with the layers of coke, producing large volumes of carbon monoxide (CO) which rise through the furnace, reducing the iron ore and transferring heat to the material higher up in the furnace. Once the iron ore has been reduced to metallic iron, the liquid metal collects lower in the furnace to be tapped, or removed, from the furnace. To reduce coke consumption, pulverised coal particles and/or combustible gases (e.g. natural gas, coke oven gas) may be injected from the tuyeres of the furnace at the bottom part.

Iron ore is often impure; therefore, limestone and other additives are used to separate these impurities from the liquid metal. For example, limestone removes sulphur from FeS to give metallic iron and CaS. The CaS, having a lower density than metallic iron, rises in the furnace and forms a layer of molten slag which also contains other impurities such as SiO₂, Al₂O₃, MgO and CaO. The slag is tapped from the furnace at ~1650° C., and up to 65% of this heat can be recuperated. Typically, around 0.275 tonnes of slag are produced per tonne of steel produced. The process gas, mixing with carbon monoxide and carbon dioxide within the furnace, rises to the top of the furnace and is known as top gas. This top gas leaves the furnace at around 200-300° C. and has a typical lower heating value of 3-4 MJ per Nm³ (normal cubic meter) much of which is recovered by regenerative heat exchangers. This heat, along with additional heat obtained through the combustion of this top gas is used to heat the blast to over 1100° C., as discussed above.

Modern steel production via BF-BOF uses (approximately) 1,370 kg of iron ore, 780 kg of metallurgical coal, 270 kg of limestone, and 125 kg of recycled steel to produce 1,000 kg of crude steel. The blast requires ~1500 kg of air which is fed into the bottom of the furnace via tuyeres (nozzles). The metallurgical coal must be treated before it can be used in the BF, being heated to ~1250° C. for ~12 hours using heat obtained from the top gas and the coke oven gas (COG). COG is the gas released from the pre-treatment of the coal once it has been quenched and cleaned. Typically, COG contains 60% H₂, 24% CH₄, 6% CO, 6% N₂, and 4% CO₂. COG is also used in the BF, since hydrogen and carbon monoxide are excellent reducing agents of iron ore. Once treated, the coke has a few main uses in a typical BF. Firstly, the coke is a major energy source for the BF, with 95% of the total energy being supplied from combustion of coke in the BF (and the coke making up 20-40% of total costs). Secondly the coke reacts with oxygen to produce carbon monoxide, an effective reducing agent for iron ore, then reacts with the carbon dioxide produced in the reduction to form more carbon monoxide according to the Boudouard reaction. The coke also adds carbon to the metallic iron. Finally, the coke acts as a support for the layers of iron ore and aids in gas movement through the furnace. Other reducing agents can also be injected in a blast furnace to reduce the amount of coke needed, such as pulverised coal (cheaper than metallurgical coal), hydrocarbons, waste plastics and biomass. Additionally, natural gas can replace some coke due to its decomposition to carbon monoxide and hydrogen, providing it has a methane content above 80%. There is an accepted minimum theoretical fuel value of 465 kg per tonne of hot metal produced, with modern BF coming close to this with 500 kg per tonne.

There are four main reactions occurring in a BF to reduce iron ore to iron. Iron ore is predominantly made of Fe₂O₃. There are two reactions occurring below 570° C.:

3Fe₂O₃+CO→2Fe₃O₄+CO₂ (1)

ΔH_{843K}=−30.050 KJ/mol

Fe₃O₄+4CO→Fe+4CO₂ (2)

ΔH_{843K}=−44.478 KJ/mol

Once the remaining iron ore has started to drop lower in the furnace and the temperature increases above 570° C., the following two reactions become dominant:

Fe₃O₄+CO→3FeO+CO₂ (3)

ΔH_{1073K}=+9.707 kJ/mol

FeO+CO→Fe+CO₂ (4)

ΔH_{1273K}=−15.653 kJ/mol, ΔH_{1473K}=−16.484 kJ/mol

With the reduction of FeO (Equation 4) requiring a CO concentration of at least 70%.

The so-called pig iron produced by the blast furnace is tapped from the BF and injected into the BOF. Scrap metal may also be charged in the BOF up to 25-30% by weight. No heat is added to the BOF, but oxygen is blown through the molten metal, reacting with carbon in the iron (often FeC) to forming carbon monoxide and carbon dioxide while releasing heat. This reaction increases the temperature to ~1650° C. The oxygen must be a minimum of 99.9% pure to allow for a large range of steel products to be made. A total of 50-60 Nm³/tls (normal cubic meters per tonne of liquid steel) is blown through a lance above or from bottom of the hot metal for 15 to 20 minutes, also called the blow. The steel will be tapped from the furnace approximately every 40 minutes. Basic Oxygen Furnace Gas (BOF Gas) exits the furnace at around ~1600° C. and ~100 Nm³/tls is produced, containing carbon dioxide, carbon monoxide and nitrogen from the environment. The temperature and composition of the BOF gas often changes with time during the process. This BOF Gas has a heating value of around 8.8 MJ/Nm³, of which over 90% can be recovered as heat and chemical energy.

FIG. 1 shows an overview of a TC-BF example system 100 according to an embodiment, comprising a reducing furnace 110 and a thermochemical reactor 130. The blast furnace 110 operates in a similar way to the example described above, except that at least some of the carbon monoxide used to reduce the iron ore is obtained, not by burning coke, but by thermochemical reduction of carbon dioxide from the blast furnace top gas 111. The blast furnace 110 receives iron ore 101 and process gas 102 (e.g. air or oxygen enriched air) along with a source of carbon (e.g. pulverised coal or natural gas, not shown) and produces hot metal 115 and blast furnace top gas 111. In this example, the reducing furnace 110 is a blast furnace 110 and the process gas 102 may be referred to as blast gas 102.

At least a portion 163 of the blast furnace top gas 111 with enriched carbon dioxide (e.g. comprising at least 20%, 50%, 75%, 85% or 95% carbon dioxide) is provided as an input to the thermochemical reactor 130. A gas separator (not shown) may be used to separate carbon dioxide from the top gas 111 to produce the carbon dioxide 163 that is provided to the thermochemical reactor 130. Any suitable technology may be used for gas separation, for example (but not limited to): sorption, membrane, or chemical acceptor.

The thermochemical reactor 130 reacts the carbon dioxide 163 with a thermochemical compound that reduces/splits the carbon dioxide to produce carbon monoxide 151, with the thermochemical compound in turn becoming oxidised. The carbon monoxide 151 is provided as an input to the blast furnace 110 for reducing iron oxide, for example mixed with the process gas 102 (or introduced directly, and not mixed with the process gas 102). The source of carbon may comprise coke, charcoal, biomass and/or waste plastics, and may be introduced at least partially with the process gas 102 (due to the lower mechanical strength of the materials in the BF and the higher proportion of volatiles under this approach, compared with the traditional coke-based system).

In embodiments, the carbon monoxide needed to reduce the iron ore in the blast furnace is at least partly provided by converting carbon dioxide from the blast furnace top gas 111 into carbon monoxide 151 by a thermochemical reaction. In some embodiments, at least: 20%, 30%, 50%, 75% or 85% of the carbon monoxide used in the blast furnace for reducing iron oxide may be provided by thermochemical conversion of carbon dioxide into carbon monoxide (which may be in-situ). This may significantly reduce the amount of coke required as an input to the blast furnace 110, and considerably reduce the carbon footprint of the blast furnace 110. The amount of coke required by the blast furnace 110 may be reduced by at least 20%, 30%, 50%, 75%, 85%, 90% or even 100% (compared with a system in which all the carbon monoxide in the blast furnace is obtained from coke). High percentages of coke reduction may require an alternative material e.g. an inert (chemically compatible) ceramic material, to act as an structural support, to ensure permeability and stability of the BF operation, and such material may be reused within the process (e.g. the structural support may not be consumed by chemical reactions in the BF).

The two main classes of materials capable of undergoing a thermochemical cycle to split carbon dioxide into carbon monoxide are simple metal oxides or mixed metal oxides, such as perovskites. Ceria (cerium oxide) is an example of a metal oxide that can split carbon dioxide with good yields; however, it requires high temperatures such as 1400° C. for reduction and 900° C. for oxidation. Ceria is a non-stoichiometric oxygen carrier meaning that less than one mole of oxygen is released per mole of ceria. Other metal oxides include the volatile metal oxides and iron oxides. Volatile metal oxides are stoichiometric oxygen carriers and have melting temperatures of the pure metal lower than the reduction temperature of the metal oxide.

Perovskites are non-stoichiometric mixed metal oxides with an ideal formula of ABO₃ with A and B being a metallic element. An example perovskite for thermochemical cycles is the La1-xSrxMnO3 family, which can be reduced at about 1400° C. and oxidised at around 900° C. with up to ten times higher fuel yields than ceria. Ba₂Ca_{0.66}Nb_{1.34}-xFeₓO₆ (x=0, 0.34, 0.66 and 1) is a double perovskite and can be reduced and made to decompose CO₂ at ~800° C. making it particularly suitable for embodiments.

Examples of suitable perovskites for carbon dioxide splitting to carbon monoxide include those listed below in Table 1 (with further examples listed in Table 2)

TABLE 1
Example perovskites for carbon dioxide splitting

| | Carbon | |
|---|---|---|
| | monoxide | Reduction/ |
| | yield | Oxidation |
| Perovskite | (μmol/g) | temperature |
| La_{0.6}Sr_{0.4}MnO₃ | 469 | 1350/1000 |
| La_{0.5}Ca_{0.5}MnO₃ | 525 | 1400/1100 |
| Y_{0.5}Sr_{0.5}MnO₃ | 757 | 1400/900 |
| Pr_{0.2}Sr_{0.8}MnO₃ | 637 | 1400/1000 |
| Sm_{0.5}Ca_{0.5}MnO₃ | 580 | 1400/1100 |
| La_{0.6}Ca_{0.4}Mn_{0.8}Ga_{0.2}O₃ | 515 | 1350/1050 |
| La_{0.5}Sr_{0.5}Mn_{0.95}SC_{0.05}O₃ | 545 | 1400/1100 |
| Ba₂Ca_{0.66}Nb_{0.34}FeO₆ | 979 | 700/800 |

In embodiments, the thermochemical reaction is reversible, with the thermochemical compound reduced to produce oxygen. This oxygen could be discarded as a waste product, or captured and sold.

In the context of a BF-BOF, oxygen produced by reduction of the thermochemical compound can be used as an input to the BOF, to provide at least part of the oxygen gas required as an input. In some embodiments, all of the oxygen for the BOF may be provided by reduction of the thermochemical compound, and a surplus of oxygen may be possible.

Many materials are capable of undergoing a thermochemical cycle, however Ba₂Ca_{0.66}Nb_{0.34}FeO₆ (BCNF1) will be used in the example embodiments described herein, due to its high yields, low reaction temperatures, 100% selectivity towards CO, and a low activation energy of the oxidation reaction. BCNF1 is a double perovskite material. When BCNF1 is reduced at 700° C. under nitrogen, oxygen is lost from the crystal structure, forming oxygen vacancies, and releasing oxygen gas

$${Ba}_{2} {Ca}_{0.66} {Nb}_{0.34} {FeO}_{6} {\to }_{700 ° C .} {Ba}_{2} {Ca}_{0.66} {Nb}_{0.34} {FeO}_{6 - δ} + \frac{δ}{2} {O}_{2} \qquad ( 5 )$$

where δ is equal to the degree of non-stoichiometry. The oxidation of BCNF1 occurs at 800° C. under carbon dioxide, causing the CO₂ to be split to CO, reincorporating the oxygen in the lattice by filling the oxygen vacancies, and reforming the original perovskite.

$${Ba}_{2} {Ca}_{0.66} {Nb}_{0.34} {FeO}_{6 - δ} + δ {CO}_{2} {\to }_{800 ° C .} {Ba}_{2} {Ca}_{0.66} {Nb}_{0.34} {FeO}_{6} + δ CO \qquad ( 6 )$$

This allows the cycle of reduction and oxidation to be repeated, splitting CO₂. BCNF1 has been found to convert 10.1% of CO₂ to CO per cycle (mean value over five cycles). Producing 150 m³/hr of CO would require 5700 kWh of electricity with an 85% efficient electric heater. This plant could produce carbon monoxide at a cost of £0.19 per kg at an electricity price of £0.11/kWh. At an electricity price of £0.05 (the average US industrial electricity price), carbon monoxide would cost £0.11 per kg.

FIG. 1a shows an overview of a TC-DRI example system according to an embodiment, comprising a direct reduction iron furnace 210 and a thermochemical reactor 230. The direct iron reduction furnace 210 operates to reduce iron in the solid phase by contacting it with a process gas, such as hydrogen or carbon monoxide. The reactions are set out below:

3Fe₂O₃+CO/H₂→2Fe₃O₄+CO₂/H₂O

Fe₃O₄+CO/H₂→3FeO+CO₂/H₂O

FeO+CO/H₂→Fe+CO₂/H₂O

At least some of the carbon monoxide used to reduce the iron ore in the DRI furnace 210 is obtained by thermochemical reduction of carbon dioxide from the top gas 211 output from the DRI furnace 210. The DRI furnace 210 receives iron ore 201 and process gas 202 (e.g. carbon monoxide and/or hydrogen) along with a source of carbon (e.g. pulverised coal or natural gas, not shown) and produces hot metal 215 and DRI top gas 211. At least a portion 263 of the DRI top gas 111 with enriched carbon dioxide (e.g. comprising at least 20%, 50%, 75%, 85% or 95% carbon dioxide) is provided as an input to the thermochemical reactor 230. A gas separator (not shown) may be used to separate carbon dioxide from the top gas 211 to produce the carbon dioxide 263 that is provided to the thermochemical reactor 230. Any suitable technology may be used for gas separation, for example (but not limited to): sorption, membrane, or chemical acceptor.

As described with reference to FIG. 1a, the thermochemical reactor 230 reacts the carbon dioxide 263 with a thermochemical compound that reduces/splits the carbon dioxide to produce carbon monoxide 251, with the thermochemical compound in turn becoming oxidised. The carbon monoxide 251 is provided as an input to the DRI furnace 210 for reducing iron oxide, for example mixed with process gas 202 (or introduced directly, and not mixed with reducing gas 202).

In embodiments, carbon monoxide used to reduce the iron ore in the DRI furnace is at least partly provided by converting carbon dioxide from the DRI furnace top gas 211 into carbon monoxide 251 by a thermochemical reaction. In some embodiments, at least: 20%, 30%, 50%, 75% or 85% of the carbon monoxide used in the DRI furnace for reducing iron oxide may be provided by thermochemical conversion of carbon dioxide into carbon monoxide (which may be in-situ). This may significantly reduce the amount of carbon required as an input to the DRI furnace 210, and considerably reduce the carbon footprint of the DRI furnace 210.

Referring to FIG. 2, a schematic of system 100 according to an embodiment is shown. The system comprises a blast furnace 110, steel furnace 120, gas separators 140, 160, 180, first thermochemical reactor 130, second thermochemical reactor 170, CO storage tank 150, O₂ storage tank 190 and controller 200. The steel furnace 120 in this example embodiment is a basic oxygen furnace/BOF 120, but in other embodiments an EAF may be used as the steel furnace 120.

Mass and molar flows within the system 100 will be discussed, with reference to the production of 1 tonne of liquid steel (1000 kg). The mass and molar flows are illustrative of a specific example, and should not be construed as limiting the scope of the invention. Other systems are possible, with different mass flows.

The blast furnace 110 receives iron ore 101, process gas 102 and carbon monoxide 151, and provides hot metal 115 to the basic oxygen furnace 120. The usual slag forming agents may also be provided as inputs to the blast furnace 101 along with a source of carbon (as discussed above). The basic oxygen furnace 120 receives the hot metal 115 and scrap steel 122, along with oxygen gas 191. The hot metal 115 and scrap steel 122 are converted to liquid steel by removal of carbon in a reaction with the oxygen 191. To produce 1000 kg of liquid steel 125, the blast furnace 110 may be provided with ~1600 kg of iron ore, and ~1500 kg of process gas. This amount of iron ore 101 is based on an assumption of 95% Fe₂O₃ and 5% impurities. The blast furnace 110 outputs ~900 kg of hot metal and ~1500 kg of blast furnace top gas 111.

The blast furnace top gas 111 contains carbon dioxide, carbon monoxide, nitrogen, and hydrogen. The basic oxygen furnace 120 produces basic oxygen furnace gas 121, comprising carbon monoxide and carbon dioxide. In this example, the hot metal is combined with ~125 kg of scrap steel in the BOF 120, but higher or lower proportions of scrap metal may be used. The BOF 120 receives ~50 Nm³ of oxygen and outputs ~100 Nm³ of BOF gas 121 (comprising CO and CO₂).

Gas separator 160 receives both the top gas 111 and the BOF gas 121, and separates these gases into three components: carbon monoxide 165, 166, carbon dioxide 163, 164, and nitrogen 161/hydrogen 162. In this example, it is assumed that the proportions of the top gas 111 are 5% CO, 45% CO₂, 2% H₂ and 48% N₂. These values are different than those that are typical for prior art coke-based blast furnaces, which produce higher proportions of CO and H₂. It is assumed that the absence (or reduced amount) of coke will result in lower CO in the top gas, since the amount of CO added is substantially stochiometric. In other embodiments, these proportions may be different. While the example is based on approximately stochiometric supply of CO to the blast furnace, there may be excess CO in the blast furnace in some examples. In this example, the proportions of the BOF gas 121 are 90% CO and 10% CO₂.

The gas separator 160 (and optionally, gas separators 140, 180) may operate using any suitable technology, for example (but not limited to): sorption (including pressure swing adsorption), membrane, or chemical acceptor. The gas separator 160 provides the carbon monoxide component 165, 166 to the carbon monoxide storage tank 150, the carbon dioxide component 163, 164 to the first thermochemical reactor 130 and the nitrogen/hydrogen component 161, 162 to the second thermochemical reactor 170.

The carbon dioxide 163, 164 from the gas separator 160 comprises two components: a first component 163 obtained from the top gas 111, and a second component 164 obtained from the BOF gas 121. The mass flow of top gas 111 is much larger than the mass flow of BOF gas 121, which means that the majority of the carbon dioxide produced by the gas separator 160 will be derived from the top gas 111. In this example ~21200 moles of CO₂ come from the top gas 111 and only ~410 moles of CO₂ come from the BOF gas 121. It can consequently be seen that collection of carbon dioxide from the BOF gas is advantageous, but not essential in all embodiments. The output of CO₂ from the BOF may be periodic.

The carbon monoxide 165, 166 from the gas separator 160 similarly comprises two components: a first component 165 obtained from the top gas 111, and a second component 166 obtained from the BOF gas 121. The mass flow of top gas 111 has a smaller proportion of CO than the BOF gas 121, which means that the contribution of CO from the BOF gas is more significant than is the case for CO₂. However, the majority (~75% in this example, but in general, more than 50%) of the CO 151 provided to the blast furnace 110 may be obtained by splitting CO₂ in the thermochemical reactor 130 to form CO. In this example, 2600 moles of CO are obtained by the gas separator 160 from the top gas 111, and 3570 moles of CO are obtained by the gas separator 160 from the BOF gas 121 (which are added to the ~15,070 moles of CO obtained from the thermochemical reactor 130).

In the example of FIG. 2, the system 100 is operating in a first mode, in which the first thermochemical reactor 130 is operating in an oxidation mode, in which the reactor 130 receives CO₂ 163, 164 from the gas separator 160, and produces CO by oxidation of the thermochemical compound. As noted above, the conversion of CO₂ to CO is not 100% for each pass through the reactor 130 (around 10% may be converted with each pass). The reactor 130 produces an oxidation product gas (OPG) 131 in which at least some of the CO₂ has been converted to CO. The OPG 131 is provided to a thermochemical reactor gas separator 140, which separates the CO₂ from the CO. The CO₂ 142 is recirculated to the reactor 130 and the CO 141 is stored in the CO storage tank 150.

In this example, the 21,610 moles of CO₂ are converted to 15,070 moles of CO. In some embodiments around 80% of the moles of the CO₂ 163, 164 input to the reactor 130 are converted and stored as CO ready for use in the blast furnace 110. In combination with the flows of CO 165, 166 from the gas separator, the CO storage tank 150 receives 21,400 moles of CO, which is provided to the blast furnace 110. Preferably, the CO 151 is injected into the blast furnace 110 via the tuyeres with the process gas 102 (but in some embodiments other CO injection points may be used, optionally in combination with injecting the CO 151 with the process gas 102).

If the reduction of iron ore to metallic iron occurs via reactions (1) and (2), for every mole of Fe₂O₃, three moles of CO are needed. If the reduction proceeded via (1), (3) and (4), two moles of CO are needed. Therefore, an approximation can made in the calculation of stoichiometric quantities needed, wherein 2.5 moles of CO are needed per mole of Fe₂O₃. This equals 23,800 moles of CO/tls.

In some embodiments, all the CO necessary for reduction of the iron ore in the blast furnace 110 can be obtained from the top gas 111, the BOF gas 121 and the thermochemical reactor 141. In the example embodiment of FIG. 2, some of the CO necessary for reduction of the iron ore in the blast furnace is provided as a gas input, and coke (or charcoal, biomass, waste plastic etc) is used (not shown) to provide the remainder of the CO (and to provide structure and to act as a source of solid carbon). In embodiments where a large percentage of coke is replaced by CO, a structural material may be provided to the BF 110 to ensure permeability and stability of the operation. Such structural material can be inert (e.g. chemically compatible ceramic balls or similar) and recycled within the process. In some embodiments, engineered carbon materials which are less reactive (unlike porous coke) may be provided with the main function of providing structure. Should CO concentration be sufficiently high, it is possible to make oxidation of carbon less favourable thermodynamically.

In the first system mode, the second thermochemical reactor 170 is operating in a reduction mode, in which the reactor 170 receives nitrogen 161 and hydrogen 162 from the gas separator 160, and produces O₂ by reduction of the thermochemical compound. The nitrogen 161 is provided as an inert carrier/purging gas, to provide the low oxygen concentration necessary for the BCNF1 to be reduced thermally. The hydrogen may improve the extent of reduction of the thermochemical compound and improve oxygen yield. The reduction product gas (RPG) 171 leaving the reactor 170 is not pure O₂: it will also comprise N₂ and H₂O (the water produced by oxidation of the hydrogen). The RPG 171 is provided to a thermochemical reactor gas separator 180, which separates the O₂ from the nitrogen, and which condenses out the water. The nitrogen 182 is recirculated to the reactor 170 and the O₂ 181 is stored in the O₂ storage tank 190.

In this example, more than 50 Nm³ of oxygen 181 are produced to the oxygen storage tank 190 from the gas separator 180. All of the oxygen 191 for the BOF 120 can consequently be provided from the oxygen storage tank 190, with the remaining oxygen 192 offered for sale. The oxygen could also be used in the BF hot blast stoves for oxy-fuel combustion.

In the example of FIG. 2, 2580 kg of BCNF1 are provided in each of the reactors 130, 170. One kg of BCNF1 produces ~5.8 moles of CO in 24 hours. In embodiments in which all of the CO used in reducing the iron ore comes from gas input, the loading of the thermochemical compound (e.g. BCNF1) in the reactors 130, 170 may be adjusted accordingly.

The reaction in the first thermochemical reactor 130 and the second thermochemical reactor 170 cannot continue indefinitely. For the example BCNF1 material, rates of production of oxygen and carbon monoxide drop after ~24 hours. Regardless of the material used, at some point in time, enough of the thermochemical compound in the reactors 130, 170 will have been reacted that rates of production will be slowed. This point can be sensed empirically based on a partial pressure of gas (e.g. CO or O₂) detected in the OPG 131 and/or RPG 171, for example based on a threshold production rate (or based on a predetermined duration such as 24 hours, or any other predetermined time period). When the appropriate time has been reached, the controller 200 may reconfigure the system to operate in a second mode, with the first reactor 130 in a reduction mode and the second reactor 170 in an oxidation mode.

Reconfiguring the system may comprise closing and opening various control valves, so that: i) the first reactor 130 receives nitrogen 161 and hydrogen 162 from the gas separator 160, and the first reactor 130 provides reduction product gas 171 to the gas separator 180, and receives recirculated nitrogen 182 from the gas separator 180; and ii) the second reactor 170 receives CO₂ 163, 164 from the gas separator 160 and recirculated CO₂ 142 from the gas separator 140, and the second reactor provides oxidation product gas 131 to the gas separator 140. In addition to operating control valves, the temperature of the first thermochemical reactor 130 may be reduced from the oxidation temperature (800° C. for BCNF1) to the reduction temperature (700° C. for BCNF1) and the temperature of the second thermochemical reactor increased from the reduction temperature (700° C. for BCNF1) to the oxidation temperature (800° C. for BCNF1).

Oxygen may be blown into the BOF 120 for 15-20 minutes, with liquid steel 125 and slag (not shown) being tapped around every 40 minutes.

A system like that illustrated in FIG. 2 has the potential to reduce CO₂ emissions by 94% compared to a typical BF-BOF, with the only emissions arising from the solid carbon source input to the blast furnace 110, since all the carbon monoxide is produced from carbon dioxide is recovered from the blast furnace 110 and BOF 120. This 94% reduction assumes that the solid carbon source is charcoal, biomass or plastic. If coke is used as a solid carbon source, the CO₂ emission reductions are ~90% (which is still a huge reduction). Even higher reductions are possible with embodiments that use gas phase CO only.

As mentioned above, embodiments are possible in which only some of the carbon monoxide is obtained by splitting carbon dioxide captured from the blast furnace 110 and/or the BOF 120. Some benefit will accrue even for relatively low amounts of CO₂ capture/conversion to CO.

Energy flows for the system illustrated in FIG. 2 are schematically illustrated in FIG. 3. FIG. 3 includes the features described with reference to FIG. 2, and additionally includes a regenerative heat exchanger 105 and a repurposed coke oven 175. A repurposed coke oven 175 may be used if the site of the BF 110 produces coke on site. An alternative source of heat may be appropriate where that is not the case.

Removing coke from the BF 110 decreases the energy available to heat the BF 110 to the required temperature. The reaction between coke and oxygen in the BF 110 is exothermic, releasing heat. A solid carbon source (e.g. 10% biomass based charcoal, added to the BF 110 as a replacement carbon source) will help in this, but additional heat, for example from electric heaters, may be needed to reach the required temperatures. The iron ore 101 could be preheated to aid in this. Such electric heaters may be powered by renewable (solar, wind) and/or other low/zero carbon (nuclear) sources.

The process gas 102 may be preheated using heat 107 obtained from top gas 111 and BOF gas 121. Top gas 111 and BOF gas 121 can provide 2.7 GJ/tls and 0.8 GJ/tls, respectively if 90% of the energy is recovered using the regenerative heat exchanger(s) 105. This heat 107 will be transferred from these gases before the outflow gas 106 from the regenerative heat exchanger 105 (comprising both the top gas 111 and BOF gas 121) is fed into the gas separator 160.

In a conventional BF-BOF, coke off-gas, BF top gas and BOF gas are often combusted after the thermal energy has been extracted to produce electricity needed for the BF-BOF. Coke off-gas may not exist in some embodiments (in which no coke may be used). In some embodiments, top gas and BOF gas are entirely recycled by the TC reactors, making electricity production from coke off gas no longer possible. In some embodiments, at least some electricity may need to be imported, for example from renewable (solar, wind) and/or zero/low-carbons sources (nuclear).

This situation is not necessarily applicable in every embodiment. In some embodiments, a smaller proportion of the coke may be replaced by CO obtained by splitting of CO₂ from the top gas and/or BOF gas. In some embodiments, only some of the top gas and/or BOF gas may be captured and recycled, leaving some available for combustion and electricity generation.

The carbon monoxide leaving the thermochemical reactor 130 is at the oxidation temperature for the thermochemical compound (800° C. for BNCF1). Depending on the thermochemical compound in use, this temperature may be a significant fraction (e.g. at least 50%) of a desirable blast temperature of 1200° C. The temperature in the CO storage tank 150 may be maintained at the oxidation temperature for the thermochemical compound. This could be achieved by heat transfer (not shown) from the oxygen 181 produced in the reduction reactor 170, since the oxygen 181 does not need to be heated before introduction into the BOF 120. As CO is constantly used by the BF 110, the amount of CO storage can be small, making it possible to store at medium temperatures (e.g. ~500-800° C., or at least 50% of the blast temperature). CO can also be stored at ambient temperature under pressure, with a thermal energy store alongside (not shown) to heat CO before it is added to the blast 102.

The BOF 120 does not require any extra heat or fuels since heat is generated by the reaction between oxygen and iron carbide (FeC).

Liquid steel 125 leaves the BOF 120 at above 1500° C. Once the steel 125 has been cast into its final shape, some heat could be recuperated for use in the system 100.

In this embodiment, the coke oven would no longer be needed for coke preparation, saving 1.1 GJ/tls of primary energy. Around 2.2 GJ/tls is needed to power the thermochemical (TC) reactors 130, 170. This means that electricity and electric heaters previously used to heat coal to 1250° C. for 12 hours could be repurposed (if on-site) to maintain the temperature in the TC reactors 130, 170 and to heat the thermochemical compound from the reduction temperature (of 700° C. for BNCF1) to the oxidation temperature (of 800° C. for BCNF1) when the reaction conditions are being switched over. Therefore, an extra 1.1 GJ/tls of electricity used to power an electric heater is likely to be necessary to run the TC reactors.

If the electricity needed to power the electric heaters and gas separators is procured from renewable sources or nuclear power plants, this would not add to the emissions of the system 100. The cost of this electricity, plus the electricity needed to power the gas separators, may be offset at least partly by savings from replacing the coke in the system.

In the example embodiments discussed above, a BF-BOF system is considered. The invention is similarly applicable to a BF-EAF system, in which the BOF is replaced by an EAF. An EAF similarly will produce flue gases, which can be separated and recycled. CO₂ present in the EAF flue gasses can be split to CO by a thermochemical reaction and any CO may be present in the EAF flue gases can be separated. At least a portion of any CO derived from EAF flue gases may be provided to the BF.

Similarly, the features described with reference to the BF-BOF system described above are relevant to a system comprising DRI. In one example of a DRI system, a DRI furnace receives iron ore and a process gas which reduces the iron ore. The process gas may comprise at least 80% (by volume) CO and H₂. At least some of the process gas may be formed using a thermochemical reactor according to an embodiment. For example, a gas separator may be configured to receive top gas from the DRI furnace, and to provide CO₂ to a thermochemical reactor as described herein. A pair of thermochemical reactors may be used, which are cycled between producing carbon monoxide from carbon dioxide, and producing oxygen by reduction of the thermochemical compound. The thermochemical reactor(s) may be used in addition to, or as an alternative to, a reformer which is arranged to receive at least some top gas and reform CO from CO₂ in the top gas.

In an example, Ba₂Ca_{0.66}Nb_{0.34}FeO₆ (BCNF1) may be synthesised by mixing stoichiometric quantities of the precursors BaCO₃, CaCO₃, Nb₂O₅ and Fe₂O₃. A solid-state reaction may be performed by grinding and mixing of the powders to form a well-mixed powder. In an example, the resulting powder was calcined in air at 1000° C. for 12 hours before being ground again to a fine powder. In the following examples, the perovskite was used as both a powder and as 10 mm pellets. To create the powder, the fine powder after calcining was sintered at 1400° C. for 24 hours, while for the pellets the calcined powder was compressed into 10 mm pellets with an isostatic pressure of 120 MPa for 1 minute, before sintering in the same way.

In a full-scale thermochemical reactor, the thermochemical compound may be configured as a highly porous structure and may comprise at least one of: thin plates, mm scale rods or balls. The thermochemical compound may be packed to provide for good thermal transfer, fluid flow and high contact area, and/or fluidised by a through flow of gas.

In order to demonstrate a TC reactor comprising BCNF1, 100 g of BCNF1 was synthesised and placed in a 25.4 mm (1 inch) reactor. During reduction at 700° C. for 24 hours, nitrogen gas was passed through the reactor at 40 ml/min. For oxidation, the temperature was 800° C. and the gas flow changed to CO₂ at 40 ml/min. This was repeated for five thermochemical cycles. For the first cycle, samples were collected and analysed by gas chromatogram (GC) every hour between hour 0 and 11. For cycles two to five, a gas sample was collected and analysed by GC every hour between hours 12 and 23. Conversion of CO₂ to CO of 10.1% per cycle was found throughout the five cycles.

FIG. 4(a) shows carbon monoxide yields of BCNF1 at different oxidation temperatures over time. It can clearly be seen that 800° C. is the optimal temperature due to significantly higher CO production than lower temperatures over all time domains. As the temperature decreases so does carbon monoxide production. The maximum CO production of 498 μmol/g (800° C., 24 hours) was used as a baseline to calculate the conversion (Xa) at each point, shown in FIG. 5(b). Plotting ln(ln(1-Xa)) against ln(t), where t is the time in seconds, gives a Hancock & Sharpe plot (FIG. 5). The slope of the plot, m (inset of FIG. 5), gives information about the type of mechanism of redox reactions, for example, when m is below one the reaction is diffusion controlled. Since for all oxidation temperatures m is greater than one, the reaction is phase boundary controlled. A linear best fit method of different phase-boundary controlled mechanisms was therefore applied to understand more about the oxidation reaction.

The reaction at 800° C. was found to have best fit with a zero-order model (R²=0.9905), suggesting that the splitting of carbon dioxide into carbon monoxide at this temperature depends only on time and not on the concentration of carbon dioxide or non-stoichiometry of the perovskite or conversion extent. This is favourable as it suggested that at this temperature the splitting reaction will occur at its maximum rate no matter how far along the reaction is. A best fit for the reaction at 700° C. was found with an Avrami-Erofeyev 4 model (R²=0.9912), where conversion is low at the beginning and end of the time period but speeds up during the middle of the time period. The reaction occurs at the same rate in all direction and the rate of conversion does not depend on the extent of conversion. Best fit could not be found in the models tested for the reaction at 750° C. Therefore, for the purposes of creating an Arrhenius plot, the reaction at 750° C. was taken to be a 50/50 mix of a zero order reaction and Avrami-Erofeyev 4.

FIG. 6(a) shows the rate constant at each temperature, as obtained from the models discussed above. The Arrhenius plot for the oxidation reaction is shown in FIG. 6(b) and gives an activation energy (Ea) of 46.6 KJ/mol. This is compared with the oxidation reaction of similar materials in Table 2. It can be seen that the activation energy of BCNF1 is lower than all lanthanum manganites (LSMO) studied except for La0.625Ca0.375Mn0.5Cr0.5O₃, suggesting the CO₂ splitting reaction is more favourable with BCNF1 than for most LSMO. This is demonstrated by the temperature required for the oxidation reaction, which is 800° C. compared with at least 1050° C. for LSMOs. When compared with barium magnesium iron niobates, an increase in the iron content decreases the activation energy. BaMg_{0.33}Nb_{0.5}Fe_{0.17}O₃ has a higher Ea than BCNF1 while BaMg_{0.33}Nb_{0.34}Fe_{0.33}O₃ has almost half the Ea of BCNF1, suggesting the CO₂ splitting reaction on this perovskite may be even more favourable than BCNF1.

TABLE 2
Activation energy of oxidation reaction under CO₂

| | Activation Energy |
|---|---|
| Perovskite | (KJ/mol) |
| Ba₂Ca_{0.66}Nb_{0.34}FeO₆ | 46.62 |
| BaMg_{0.33}Nb_{0.67}O₃ | 92.6 |
| BaMg_{0.33}Nb_{0.5}Fe_{0.17}O₃ | 69.5 |
| BaMg_{0.33}Nb_{0.34}Fe_{0.33}O₃ | 24.1 |
| La_{0.625}Ca_{0.375}MnO₃ | 54.78 |
| La_{0.625}Sr_{0.375}MnO₃ | 68.65 |
| La_{0.625}Ca_{0.375}Mn_{0.5}Al_{0.5}O₃ | 92.23 |
| La_{0.625}Sr_{0.375}Mn_{0.5}Al_{0.5}O₃ | 78.11 |
| La_{0.625}Ca_{0.375}Mn_{0.5}Cr_{0.5}O₃ | 43.37 |
| La_{0.625}Sr_{0.375}Mn_{0.5}Cr_{0.5}O₃ | 54.59 |
| La_{0.625}Ca_{0.375}Mn_{0.5}Fe_{0.5}O₃ | 75.59 |
| La_{0.625}Sr_{0.375}Mn_{0.5}Fe_{0.5}O₃ | 75.7 |
| La_{0.625}Ca_{0.375}Mn_{0.5}Ga_{0.5}O₃ | 90.36 |
| La_{0.625}Sr_{0.375}Mn0,5Ga_{0.5}O₃ | 74.49 |

A thermochemical reactor according to an embodiment may comprise perovskite particles or a porous structure with an appropriate characteristic size provided as a packed bed, or as a fluidised bed. A packed bed allows the carbon dioxide to come into contact with a large surface area of perovskite, and a fluid bed may provide for even higher conversions due to enhanced solid and gas mixing and heat and mass transfer.

The TC-BF and TC-BF-BOF systems proposed herein have the potential to contribute to the decarbonisation of the steel industry and other extractive metallurgical industries, both within the UK and worldwide. As an example, the UK has five steel producing companies; Tata Steel and British Steel which operate BF-BOFs, and British Steel, Liberty Steels and Outokumpu which operate EAFs. Six million tonnes of steel products are made via the BF-BOF route out of the 7.65 million tonnes produced in the UK annually. BF-BOFs in the UK therefore account for around 94% of total emissions of the UK Steel sector based on an emissions intensity of 1.89 tCO_{2eq}/tls (tonnes of CO₂ equivalent per tonne of liquid steel) for the BF-BOF route and 0.44 tCO_{2eq}/tls for the EAF route. EAFs can be more easily decarbonised with the use of renewable electricity and/or 100% recycled steel. On the other hand, decarbonising a BF-BOF is far more difficult due to the inherent carbon intensive nature of the process. Their decarbonisation is crucial for the UK to reach its net-zero emissions goal by 2050, and more widely to avoid problematic climate change, which is a global problem.

Tata Steel and British Steel both produce around three million tonnes of steel a year at their Port Talbot and Scunthorpe sites, respectively. Due to the similar production values, the same TC-BF-BOF system can be used in both cases, as described hereafter. Taking BCNF1 as an example TC compound, 42,500 tonnes of BCNF1 would be required to produce the 124 million moles a day of carbon monoxide necessary to displace 90% of the coke, with the remaining 10% displaced by a solid carbon source such as biomass-based charcoal. The TC compound could be split into ten TC reactors that are 15 m tall and 9.5 m in diameter, with five reactors undergoing reduction and five undergoing oxidation at any one time. The raw materials to produce the required amount of BCNF1 would cost £210 million, which may need to be replaced every 5-10 years or so. In addition to the CO, these reactors would produce 1.3 million m³ of oxygen a day, of which 420,000 m³ would be required in the BOF. The excess oxygen production could generate £35,000/day. The displacement of 90% of the coke by CO would save £187 million a year.

Approximate energy requirements to power the TC cycle of the example embodiment are 3.6 TJ per reactor for a full cycle of reduction and oxidation over 48 hours. The reduction reaction uses 85% of this energy due to the high endothermic enthalpy of reduction of 620 KJ/kg, while the enthalpy of oxidation is exothermic and therefore releases energy (−45.1 KJ/kg). The implementation of the TC-BF-BOF system requires an additional 2.2 GJ/tls, where a typical BF-BOF requires between 19.8 and 31.2 GJ/tls. The now redundant coke oven could be repurposed to produce 1.1 GJ/tls of heat. As discussed above, there are large amounts of energy in the top gas and BOF gas. If 90% of this energy is recovered via the regenerative heat exchangers, this equals 3.5 GJ/tls, higher than the energy use of the TC system. Alternatively, if the TC reactors were exclusively powered by electricity, it would require 607 kWh/tls, costing around £42/tls. This is drastically lower than hydrogen direct reduced iron (HDRI) which requires 3.72 MWh/tls. If this was taken from the UK grid electricity, which has an emissions factor of 212 gCO_{2eq}/kWh, this would produce 129 kgCO_{2eq}/tls, equal to 6.9% of current emissions per tonne of liquid steel. Both financially and environmentally, using as high a share of renewable electricity and/or nuclear power as possible is beneficial.

Significantly, implementation of the example TC-BF-BOF system would reduce emissions from 5.7 million tonnes CO_{2eq} per site to 340,000 tonnes CO_{2eq}. Even if no improvements in emissions were seen from the EAF plants in operation, implementation of this system would reduce UK steel emissions by 88% and the share of emissions from BFs would decrease from 94% to 48%. Currently, the UK Steel industry emits 12 million tonnes of CO_{2eq} of the total 369 million tonnes CO_{2eq} of the UK as a whole, meaning steel represents almost 3.3% of UK emissions. Implementing the TC-BF-BOF system at the Tata Steel and British Steel plants would decrease the steel-based share of UK emissions to 0.38%. Therefore a 2.9% reduction in UK emissions can be realised with ~£720 million in capital expenditure, with ongoing expenditure of ~£400 million every 5-10 years to replace the spent BCNF1 material once activity has dropped. Additionally, there are significant operational expenditure reductions achieved from the implementation of this system, due primarily to the displacement of expensive metallurgical coal. The capital expenditure could be entirely repaid from these savings in 22 months, with total savings of £1.28 billion after 5 years. The possible small increase in electricity consumption on implementation of this system would be easily absorbed in these savings. This system would also decrease the price of steel production, increasing the competitiveness of steel produced with this approach on the global market.

Although the example above relates to the sort of implementation shown in FIG. 2, it should be understood that benefits are also available from embodiments in which a reduced fraction of the coke is replaced by CO obtained by TC splitting of CO₂ produced by the blast furnace and/or BOF.

Embodiments may have several advantages, when compared with other methods of decarbonising the iron and steel sector. Firstly, embodiments may make use of existing BF-BOFs, which make up 70% of steel production, thereby preventing the formation of stranded assets. Given that the global switch to a net-zero economy is likely to create stranded assets in multiple sectors incompatible with net-zero, any system which minimises stranded assets while achieving drastic emissions reductions should be prioritised. Furthermore, the continued operation of BF-BOFs globally would ensure the preservation of highly skilled jobs and could create new jobs for the management and operation of the TC reactors. Secondly, the emissions reductions are evident as soon as a TC-BF or TC-BF-BOF retrofit is installed, rather than waiting years for a new DRI-EAF to be built or for decarbonisation of the electricity grid for emissions reductions to be realised. This system can operate a nearly perfect closed carbon loop, where any CO₂ produced in the BF or BOF are fed into TC reactors to be split into more carbon monoxide for use in the BF. Additionally, the system provides an additional, albeit small, income in the form of selling the extra oxygen produced in the TC reactors (equal to around £13 million a year each for the UK's two BF-BOF plants).

Another important factor is that since the TC-BOF or TC-BF-BOF is economically viable and potentially saves as much as £600 million per plant over five years, making the cost of producing steel potentially lower than with a traditional BF-BOF. In addition to cheaper steel production, the steel produced could also be considered carbon-neutral steel, which is likely to fetch a premium as companies and governments try to reduce operational and entrenched emissions in a wide range of sectors. The emissions intensity of steel created via TC-BF-BOF could be up to four times lower than a DRI-EAF plant. Most importantly, implementation of the TC-BF-BOF system does not exclude other efforts to decarbonise the sector such as efficiency improvements, the use of renewable electricity, increased scrap recycling or methods of improving the DRI-EAF route. Indeed, to maximise sector-wide emissions reduction, the majority of scrap could be used in EAFs (where 100% scrap can be used) with the remaining scrap being used in the TC-BF-BOF.

The invention is not limited to the embodiments hereinbefore described, which may be varied in construction and detail. The scope of the invention should be determined with reference to the appended claims.

What is claimed is:

1.-25. (canceled)

26. A system for metal production, the system comprising:
a blast furnace configured to receive metal ore and blast gas and to output hot metal and blast furnace top gas; and
a first thermochemical reactor configured to, in a first mode, receive at least a portion of the reducing furnace top gas, and to produce carbon monoxide from carbon dioxide in the portion of the reducing furnace top gas by oxidation of a thermochemical compound and to return at least a portion of the produced carbon monoxide to the reducing furnace;
wherein the first thermochemical reactor is configured to, in a second mode, produce oxygen by reduction of the thermochemical compound, and.
further comprising a controller configured to switch or cycle between the first mode, in which the first thermochemical reactor receives carbon dioxide from the blast furnace top gas and produces carbon monoxide by oxidation of the thermochemical compound, and a second mode in which the first thermochemical reactor produces oxygen by reduction of the thermochemical compound.

27. The system of claim 26, further comprising a gas separator configured to: receive the blast furnace top gas, separate carbon dioxide from the other constituents of the blast furnace top gas, and provide the carbon dioxide portion of the blast furnace top gas to the first thermochemical reactor.

28. The system of claim 26, wherein the gas separator is further configured to separate carbon monoxide from the other constituents of the blast furnace top gas for returning to the blast furnace.

29. The system of claim 26, wherein the thermochemical compound comprises a metal oxide, perovskite material or a double perovskite material.

30. The system of claim 26, wherein the system further comprises a second thermochemical reactor, wherein in the first mode, the second thermochemical reactor produces oxygen by reduction of the thermochemical compound, and in the second mode, the second thermochemical reactor receives carbon dioxide from the blast furnace top gas and produces carbon monoxide by oxidation of the thermochemical compound.

31. The system of claim 26, further comprising a steel furnace, configured to receive the hot metal from the blast furnace and the oxygen from the first thermochemical and/or the second thermochemical reactor, and to output molten steel and steel furnace gas.

32. The system of claim 31, further comprising a gas separator configured to: receive the blast furnace top gas, separate carbon dioxide from the other constituents of the blast furnace top gas, and provide the carbon dioxide portion of the blast furnace top gas to the first thermochemical reactor, wherein the gas separator is configured to:
separate nitrogen from the blast furnace top gas and to provide the nitrogen to the first thermochemical reactor and/or the second thermochemical reactor for reduction of the thermochemical compound; and/or
separate carbon monoxide from the steel furnace gas for returning to the blast furnace.

33. The system of claim 26, further comprising:
a regenerative heat exchanger, configured to receive the steel furnace gas and to provide heat from the steel furnace gas to the blast gas and/or returned carbon monoxide; and/or
a blast furnace electrical heater configured to use electrical power to heat the blast gas and/or the metal ore introduced to the blast furnace.

34. The system of claim 26, further comprising a first thermochemical reactor gas separator, configured to receive an output gas from the first thermochemical reactor in the first mode, and to separate carbon monoxide from the output gas.

35. The system of claim 26, wherein the system further comprises a second thermochemical reactor, wherein in the first mode, the second thermochemical reactor produces oxygen by reduction of the thermochemical compound, and in the second mode, the second thermochemical reactor receives carbon dioxide from the blast furnace top gas and produces carbon monoxide by oxidation of the thermochemical compound, and wherein the first thermochemical reactor and second thermochemical reactor are together configured to provide at least 50% of carbon monoxide used in the blast furnace for reducing the metal ore to hot metal.

36. A method of producing steel, comprising:
reducing metal ore in a blast furnace to produce hot metal by reacting carbon monoxide with metal oxide, thereby producing carbon dioxide;
providing at least some of the carbon dioxide produced from the blast furnace to a first thermochemical reactor and producing carbon monoxide from the carbon dioxide by oxidation of a thermochemical compound;
returning at least a portion of the produced carbon monoxide to the blast furnace; and
further comprising producing oxygen by reduction of the thermochemical compound in the first thermochemical reactor and switching or cycling between a first mode in which the thermochemical reactor receives carbon dioxide from the blast furnace top gas and produces carbon monoxide by oxidation of the thermochemical compound, and a second mode in which the first thermochemical reactor produces oxygen by reduction of the thermochemical compound.

37. The method of claim 36, wherein the carbon dioxide from the blast furnace provided to the first thermochemical reactor is obtained by separating carbon dioxide from blast furnace top gas produced by the blast furnace.

38. The method of claim 37, wherein the method further comprises separating carbon monoxide from the blast furnace top gas and returning the carbon monoxide to the blast furnace.

39. The method of claim 36, wherein the thermochemical compound comprises a metal oxide, perovskite material or a double perovskite material.

40. The method of claim 36, wherein in the first mode, a second thermochemical reactor produces oxygen by reduction of the thermochemical compound, and in the second mode, the second thermochemical reactor receives carbon dioxide from the reducing furnace top gas and produces carbon monoxide by oxidation of the thermochemical compound.

41. The method of claim 36, further comprising receiving the hot metal and the oxygen from the thermochemical reactor at a steel furnace, and outputting molten steel and steel furnace gas from the steel furnace; and
separating nitrogen from the reducing furnace top gas and providing the nitrogen to the first thermochemical reactor and/or the second thermochemical reactor for reduction of the thermochemical compound.

42. The method of claim 36, further comprising separating carbon monoxide from an output gas from the first thermochemical reactor in the first mode, and separating oxygen from the output gas in the second mode.

43. The method of claim 36, further comprising:
using the first thermochemical reactor and second thermochemical reactor to provide at least 50% of carbon monoxide used in the reducing furnace for reducing the metal ore to hot metal, and/or
reducing CO₂ emissions associated with the reducing furnace by at least 50% by replacing coke used as an input to the reducing furnace with gas phase carbon monoxide obtained from output gases.

44. The method of claim 36, further comprising using electrical power to heat the process gas and/or the metal ore introduced to the reducing furnace.

45. The system of claim 26, wherein the reducing furnace is a DRI furnace or wherein the reducing furnace is a blast furnace.
